(19) United States
(12) Patent Application Publication
(10) Pub. No.: US 2012/0098751 A1
(43) Pub. Date: Apr. 26, 2012

(54) ILLUMINATED COMPUTER INPUT DEVICE

(75) Inventor: YUNG-LUNG LIU, Ta Ya Shiang (TW)

(73) Assignee: Sunrex Technology Corp., Ta Ya Shiang (TW)

(21) Appl. No.: 12/910,798

(22) Filed: Oct. 23, 2010

(51) Int. Cl. G06F 3/02; G06F 3/041

(52) U.S. Cl. 345/170; 345/173

(57) ABSTRACT

An illuminated computer input device includes a microprocessor; a touch pad module comprising a flexible, optically transmissive touch pad and a touch pad controller electrically interconnecting the touch pad and the microprocessor; a virtual keys sheet functioning as a flexible, rectangular, optically transmissive characters printing membrane and disposed under the touch pad; and a FOLED module comprising a FOLED sheet disposed under the virtual keys sheet, and a light controller electrically interconnecting the FOLED sheet and the microprocessor for adjusting brightness of the FOLED sheet.

### BACKGROUND OF THE INVENTION

1. Field of Invention

The invention relates to computer input devices and more particularly to an illuminated computer input device having FOLEDs (Flexible Organic Light Emitting Diodes) as backlight source.

2. Description of Related Art

Laptops are widely used by people through out the world due to lightweight and compactness. Typically, a laptop is equipped with a membrane keyboard having a scissors type structure. The scissors type structure is mounted between upper keycaps and a lower rubber plate.

There is a thin profile lighted keyboard including keys, scissors type structures, a rubber plate, a luminescence board, a membrane circuit board, and a base board. Each key has a top face coated with a light permeable substrate layer, a light impermeable coating layer, and a light permeable protection layer. Each scissors type structure is pivoted between each key and the rubber plate. The luminescence board is mounted between the rubber plate and the membrane circuit board so as to emit light of single color for illuminating the printed characters, symbols, and numbers on key tops. This enables a user to operate the computer in a dark environment.

Touch panels, touch pads, and touchscreens are developed as technology advances. They are widely employed in mobile phones, laptops, etc. Moreover, OLEDs (Organic Light Emitting Diodes) are newly developed. In OLED, the emissive electroluminescent layer is a film of organic compounds that emits light when an electric current passes through it. This layer of organic semiconductor material is formed between two electrodes. OLEDs are used in television screens, computer monitors, small, portable system screens such as mobile phones and PDAs, watches, advertising, information and indication. OLEDs can also be used in light sources for general space illumination and in large-area light-emitting elements. Due to their comparatively early stage of development, they typically emit less light per unit area than inorganic solid-state based LEDs (Light Emitting Diodes) similarly designed for use as point-light sources. An OLED display functions without a backlight and so can display deep black levels and can be thinner and lighter than established liquid crystal displays. Similarly, in conditions of low ambient light such as dark rooms, an OLED screen can achieve a higher contrast ratio than either an LCD screen using cold cathode fluorescent lamps or the more recently developed LED backlight.

There is a type of illuminated keyboard commercially available. LEDs (Light Emitting Diodes) are disposed on a PCB (Print Circuit Board). LED light is allowed to reach upper layers (i.e., keys) of the keyboard for illumination. However, the traveling path of the LED light is relatively long, i.e., not sufficient light emitted to the keys and light distribution being not even. Thus, quality of such type of illuminated keyboards is poor. Thus, the need for improvement still exists.

### SUMMARY OF THE INVENTION

It is therefore one object of the invention to provide an illuminated computer input device having a FOLED (Flexible Organic Light Emitting Diode) sheet as backlight so that purposes including uniform key lighting, lower operating voltage, and energy saving can be achieved.

In one aspect of the invention there is provided an illuminated computer input device comprising a microprocessor; a touch pad module comprising a flexible, optically transmissive touch pad and a touch pad controller electrically interconnecting the touch pad and the microprocessor; a virtual keys sheet functioning as a flexible, rectangular, optically transmissive characters printing membrane and disposed under the touch pad; and a FOLED (Flexible Organic Light Emitting Diode) module comprising a FOLED sheet disposed under the virtual keys sheet, and a light controller electrically interconnected the FOLED sheet and the microprocessor for adjusting brightness of the FOLED sheet.

In another aspect of the invention there is provided an illuminated computer input device comprising a microprocessor; a virtual keys sheet functioning as a flexible, rectangular, optically transmissive characters printing membrane; a FOLED (Flexible Organic Light Emitting Diode) module comprising a FOLED sheet disposed under the virtual keys sheet, and a light controller electrically connected to the FOLED sheet; and a touch pad module disposed under the FOLED module and comprising a flexible touch pad and a touch pad controller electrically connected to the touch pad, wherein the light controller is electrically interconnected to the FOLED sheet and the microprocessor for adjusting brightness of the FOLED sheet.

In a further aspect of the invention there is provided an illuminated computer input device comprising a plurality of transparent, rectangular keys each having a top coated with a bottom multi-color, optically transmissive dye layer and an opaque layer having portions removed so that characters printed between the key and the multi-color, optically transmissive dye layer can be viewed through the removed portions of the opaque layer; a plurality of scissors shaped structures disposed under the keys, each scissors shaped structure comprising a first frame and a second frame pivotally secured together; an optically transmissive rubber plate disposed under the scissors shaped structures and comprising a plurality of units of holes; a membrane circuit board disposed under the rubber plate; a rectangular aluminum plate disposed under the membrane circuit board and comprising a plurality of units each including a plurality of openings for passing light to the undersides of the keys, a plurality of snapping grooves, and a slide guide groove wherein the corresponding snapping grooves, the slide guide groove, and the scissors shaped structure are secured together; and a FOLED sheet disposed under the aluminum plate for serving as backlight of the keys.

The above and other objects, features and advantages of the invention will become apparent from the following detailed description taken with the accompanying drawings.

### BRIEF DESCRIPTION OF THE DRAWINGS

FIG. 1 is an exploded view of an illuminated computer input device according to a first preferred embodiment of the invention;

FIG. 2 is a block diagram of major components of the illuminated computer input device shown in FIG. 1;

FIG. 3 is a longitudinal sectional view of the FOLED sheet shown in FIG. 1;

FIG. 4 is an exploded view of an illuminated computer input device according to a second preferred embodiment of the invention;

FIG. 5 is a block diagram of major components of the illuminated computer input device shown in FIG. 4;

FIG. 6 is a block diagram of the electronic paper display module shown in FIG. 5;

FIG. 7 is an exploded view of an illuminated computer input device according to a second preferred embodiment of the invention;

FIG. 8 is an exploded view of portions of the illuminated computer input device shown in FIG. 7;

FIG. 9 is a longitudinal sectional view of the assembled components shown in FIG. 8; and

FIG. 10 is a detailed view of the area in circle A of FIG. 9.

### DETAILED DESCRIPTION OF THE INVENTION

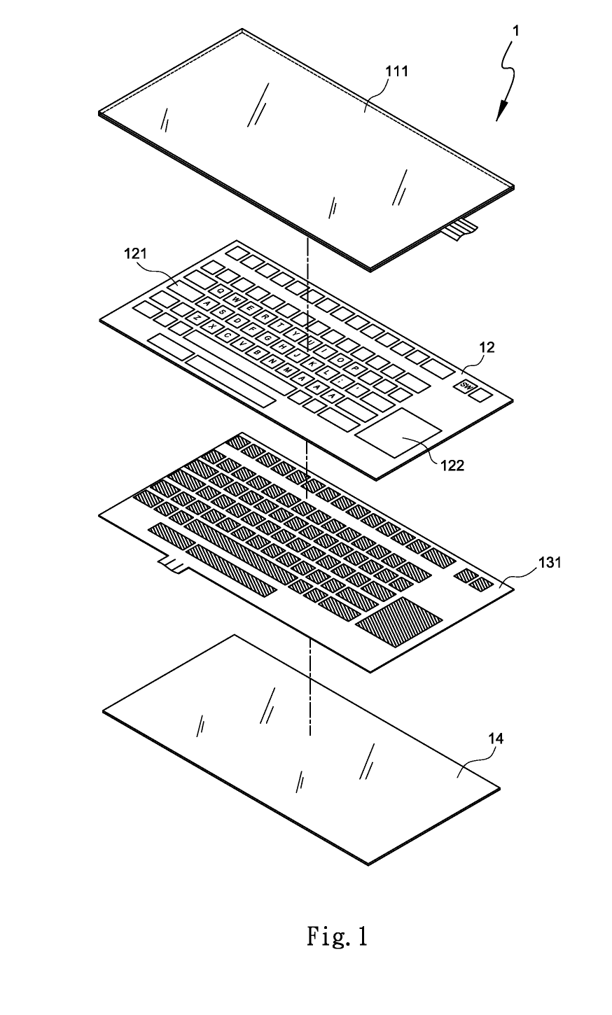

Referring to FIGS. 1 to 3, an illuminated computer input device 1 in accordance with a first preferred embodiment of the invention comprises the following components as discussed in detail below.

A touch pad module 11 comprises a rectangular, flexible, optically transmissive touch pad 111 and a touch pad controller 112. The touch pad 111 comprises a top ITO (Indium Tin Oxide) glass and a bottom ITO film separated by a plurality of spacers therebetween. Touch pad is a well known device so that a detailed description thereof is omitted herein for the sake of brevity. The touch pad controller 112 is electrically interconnected the touch pad 111 and a microprocessor 15 which is in turn electrically connected to a host computer (not shown). The touch pad controller 112 is capable of converting an analog signal generated by pressing the touch pad 111 by a user into a digital signal, calculating position of the finger touch in the form of coordinate position, converting the coordinate position into a touch signal, and sending the touch signal containing the coordinate position to the microprocessor 15 via a serial bus, thereby effecting a touch pad input. A loudspeaker or a vibrator (both not shown) can be activated when the touch signal is created so as to either audibly or physically alert the user about the successful touch.

A virtual keys sheet is implemented as a characters printing membrane 12 in the embodiment. The characters printing membrane 12 is flexible, rectangular and is provided under the touch pad 111. A top surface of the characters printing membrane 12 is provided with a plurality of virtual keys 121 each printed with a character, number, or function number, and a touch area 122 to the right. By configuring as above, a user may press a virtual key 121 to input, for example, a letter or a computer command. Alternatively, the user may use his or her finger to move on the touch area 122 to operate the touch area 122 as a computer mouse.

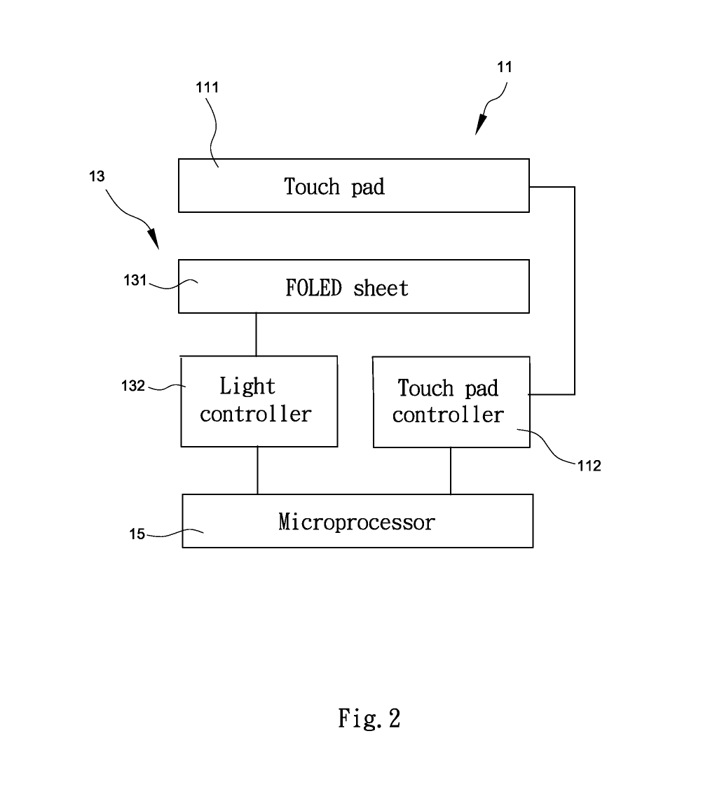

A FOLED (Flexible Organic Light Emitting Diode) module 13 comprises a rectangular FOLED sheet 131 and a light controller 132 (see FIG. 2). The FOLED sheet 131 is provided under the characters printing membrane 12 and is served as backlight source of the illuminated computer input device 1. The light controller 132 can adjust brightness of the FOLED sheet 131.

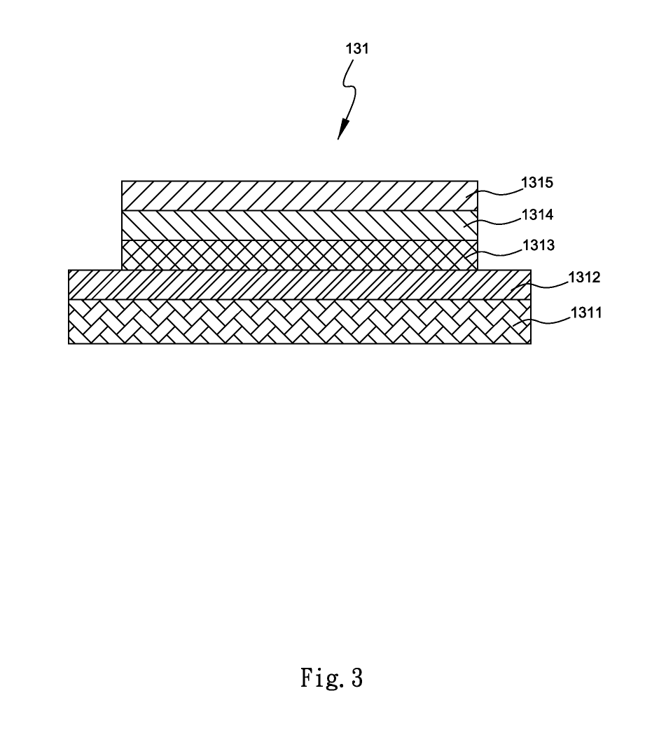

As shown in FIG. 3, the FOLED sheet 131 comprises, from bottom to top, a flexible polymeric substrate 1311, a moisture and oxygen barrier layer 1312 adhered to the polymeric substrate 1311, a metal negative layer 1313 adhered to the moisture and oxygen barrier layer 1312 and formed of magnesium or silver alloy, a light emitting layer 1314 adhered to the metal negative layer 1313 and formed of OLED (organic light emitting diode), and a positive layer 1315 adhered to the light emitting layer 1314 and formed of ITO.

The OLED is sensitive to both moisture and oxygen. Typically, about 0.1 to 100 g/m² of moisture may permeate a plastic plate per day in room temperature (e.g., 25° C.). This is not accepted by the invention. It is envisaged by the invention that a moisture and oxygen barrier layer 1312 is adhered between the polymeric substrate 1311 and the metal negative layer 1313 which is an inorganic conduction layer. It is noted that the process of applying the moisture and oxygen barrier layer 1312 should be defect-free without pin holes being occurred. Moreover, the moisture and oxygen barrier layer 1312 is optically transmissive and can absorb a minimum of light passing through. Thus, the purposes of preventing moisture and oxygen from entering the computer input device 1 can be obtained. As a result, the multi-layered structure of the FOLED sheet 131 is formed.

FOLED has the following characteristics: Emitted light can be at an angle of divergence of more than 165-degree. Response time is quick (e.g., about less than 1 μs). High light emitting efficiency. Low operating voltage (e.g., about 3-9 DC volt). Small thickness (i.e., thin) so that a large screen FOLED device can be produced. It is envisaged by the invention that the FOLED sheet 131 as backlight source of the illuminated computer input device 1 can greatly decrease the manufacturing cost, increase light emitting efficiency, and save energy.

A flexible, rectangular bottom plate 14 is formed of insulative material. The bottom plate 14 is provided under the FOLED sheet 131 as computer input device support and reflector.

A microprocessor 15 is electrically connected to both the touch pad controller 112 and the light controller 132. Also, the microprocessor 15 is electrically connected to a host computer so as to send a touch signal from the touch pad module 11 to the host computer for further processing.

In another configuration of the embodiment, the touch pad 111 is provided under the FOLED sheet 131 which is in turn provided under the virtual keys sheet (e.g., characters printing membrane 12). The purpose of illuminating computer input device by backlight still can be achieved.

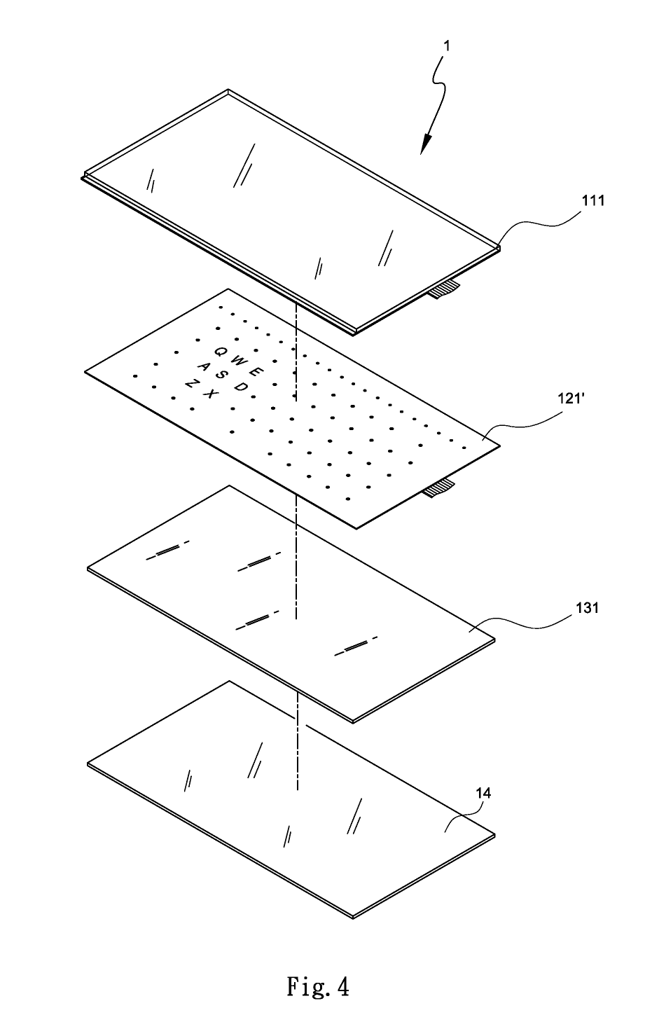

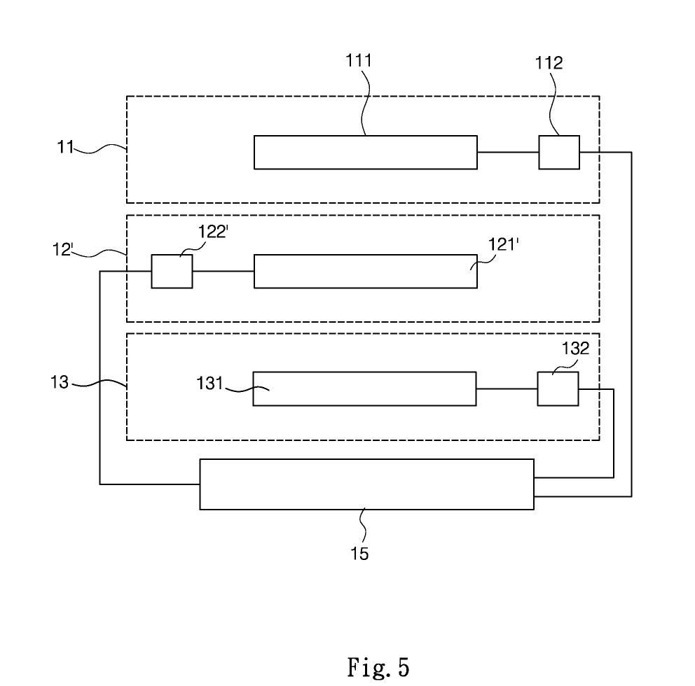

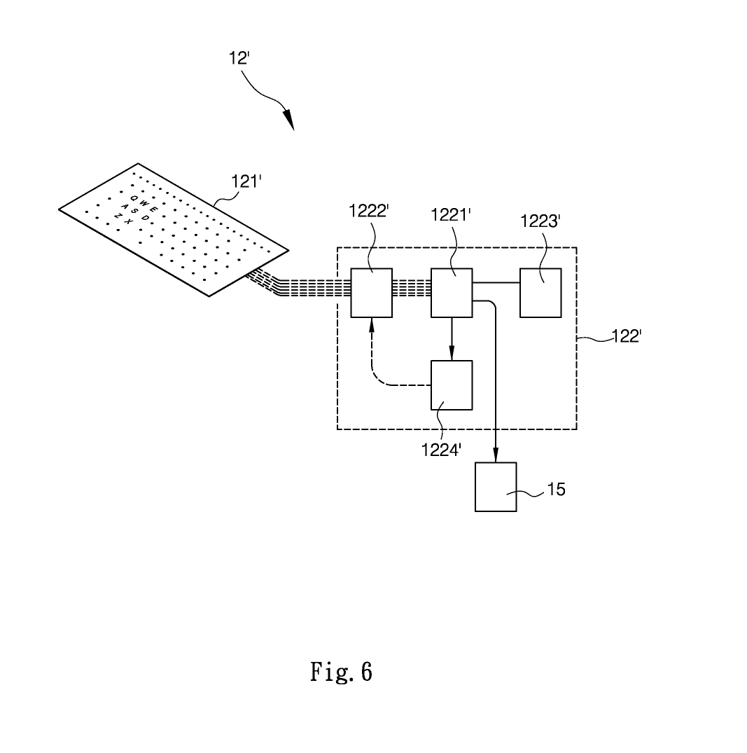

Referring to FIGS. 4 to 6, an illuminated computer input device 1 in accordance with a second preferred embodiment of the invention is shown. The characteristics of the second preferred embodiment of the invention are discussed in detail below.

The characters printing membrane 12 of the first preferred embodiment is replaced with an electronic paper display module 12′. In short, the characters printing membrane 12 is replaced with an electronic paper display 121′.

The electronic paper display module 12′ comprises an electronic paper display 121′ and an electronic paper display controller 122′. The electronic paper display 121′ is provided under the touch pad 111. The electronic paper display controller 122′ comprises a display micro-controller 1221′ electrically connected to the microprocessor 15 for controlling display signals of the electronic paper display 121′, a driver chip 1222′ for sending the display signals from the display micro-controller 1221′ to the electronic paper display 121′, an SRAM (Static Random Access Memory) 1223′ for storing a plurality of pages of different national layouts including characters and symbols, and a power supply 1224′ for supplying power to the driver chip 1222′ as controlled by the display micro-controller 1221′.

The electronic paper display 121′ is implemented as an electrophoretic display and can form visible images by rearranging charged pigment particles using an applied electric field. In a simplest implementation of an electrophoretic display, titanium dioxide particles approximately one micrometer in diameter are dispersed in hydrocarbon oil. A dark-colored dye is also added to the oil, along with surfactants and charging agents that cause the particles to take on an electric charge. This mixture is placed between two parallel, conductive plates separated by a gap of 10 to 100 micrometres. When a voltage is applied across the two plates, the particles will migrate electrophoretically to the plate bearing the opposite charge from that on the particles. When the particles are located at the front viewing side of the display, it appears white, because light is scattered back to the viewer by the high-index titanium particles. When the particles are located at the rear side of the display, it appears dark, because the incident light is absorbed by the colored dye. If the rear electrode is divided into a number of pixels, then an image can be formed by applying the appropriate voltage to each region of the display to create a pattern of reflecting and absorbing regions. Electronic paper displays have the potential to be more comfortable to read than conventional displays. This is due to the stable image, which does not need to be refreshed constantly, the wider viewing angle, and the fact that it reflects ambient light rather than emitting its own light. An electronic paper display can be read in direct sunlight without the image appearing to fade. Moreover, on the electronic paper display 121′, there are provided at least two selection keys (not shown). A user may press one of the selection keys to activate the microprocessor 15 to access a desired layout (i.e., national layout) from the SRAM 1223′ to display on the electronic paper display 121′.

In another configuration of the embodiment, the touch pad 111 is replaced with an opaque touch pad which is provided under the FOLED sheet 131 which is in turn provided under the electronic paper display 121′. The purposes of national layout changing and illuminating computer input device by backlight still can be achieved.

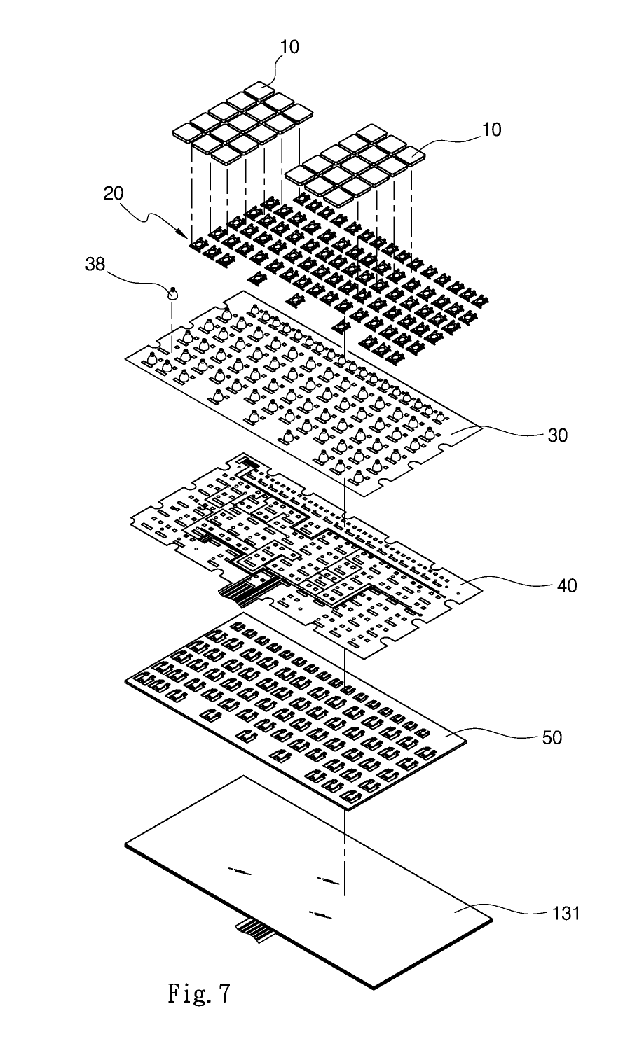

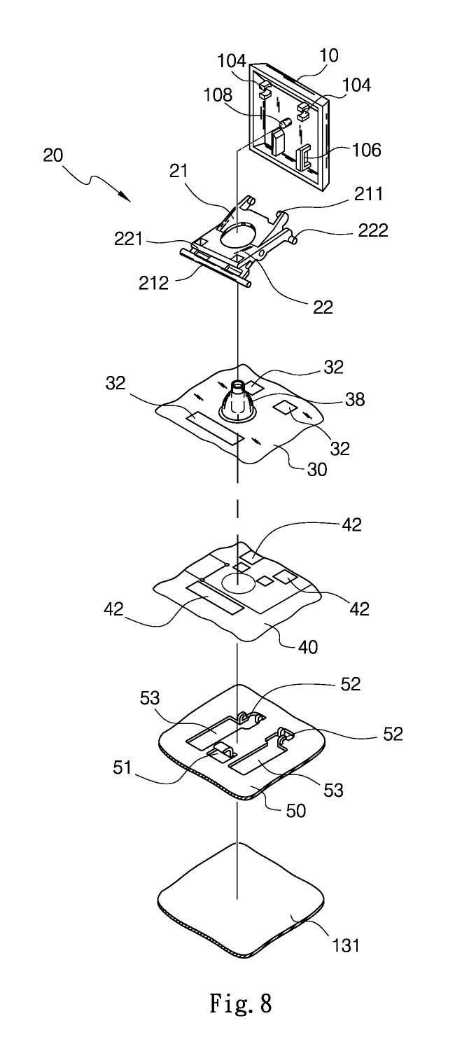

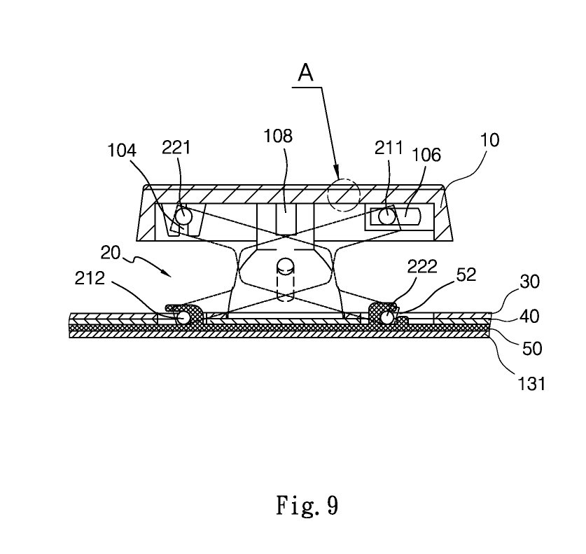

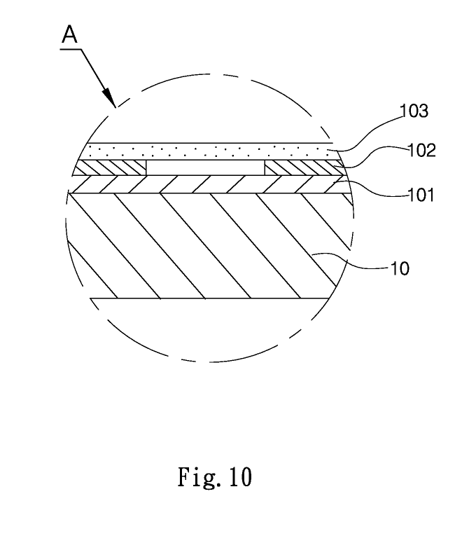

Referring to FIGS. 7 to 10 in conjunction with FIG. 2, an illuminated computer input device 1 in accordance with a third preferred embodiment of the invention is shown. The characteristics of the third preferred embodiment of the invention are discussed in detail below.

The illuminated computer input device 1 comprises a plurality of optically transmissive keys 10, a plurality of scissors shaped structures 20, a rubber plate 30, a membrane circuit board 40, an aluminum plate 50, and a FOLED module 13. Each component will be discussed in detailed below.

The key 10 is transparent, rectangular. A user may press the key 10 for data input, etc. On the bottom of the key 10, there are provided two pivot grooves 104, two slide guide grooves 106 together with the pivot grooves 104 arranged as four corners of a virtual quadrilateral, and a stem 108 extending downward from center. On top of the key 10 there are coated with, from bottom to top, a multi-color, optically transmissive dye layer 101 so that different areas of the key top may have different colors (i.e., the key 10 being colorful), an opaque layer 102 having portions removed by laser oblation so that characters printed or engraved between the key 10 and the multi-color, optically transmissive dye layer 101 can be viewed through the removed portions of the opaque layer 102, and a transparent protective layer 103 for protecting the layers and characters therebelow. Key characters may be grouped as a plurality of groups of different colors so that a user may easily distinguish characters prior to pressing the transparent keys 10.

The scissors shaped structures 20 are disposed under the keys 10. The scissors shaped structure 20 comprises two first slide axles 211 at two corners of a first frame 21, two second pivot shafts 222 at two corners of a second frame 22 pivotal about the first frame 21, the second pivot shafts 222 being below the first slide axles 211, a first pivot shaft 221 at the other side of the second frame 22, a second slide axle 212 at the other side of the first frame 21 parallel to and below the first pivot shaft 221, and a central circular hole (not numbered). The first slide axles 211 are slidably secured to the slide guide grooves 106 and the first pivot shaft 221 is rotatably secured to the pivot grooves 104 respectively.

The rubber plate 30 is optically transmissive and is disposed under the scissors shaped structures 20. On the rubber plate 30 there are provided a plurality of units of a resilient dome 38 through the hole of the scissors shaped structure 20 to retain the stem 108, and three rectangular holes 32 each with the second slide axle 212 or the second pivot shafts 222 disposed therein.

The membrane circuit board 40 is provided under the rubber plate 30 and comprises a circuitry (not numbered) and a plurality of openings 42 each with the second slide axle 212 or the second pivot shafts 222 disposed therein.

The aluminum plate 50 is provided under the membrane circuit board 40. The aluminum plate 50 is a rectangular support and comprises a plurality of units each corresponding to the scissors shaped structure 20. Each unit of the aluminum plate 50 comprises two parallel openings 53 for passing light to the undersides of the keys 10, two snapping grooves 52 each at one end of the opening 53 for retaining the second pivot shafts 222, and a slide guide groove 51 between the other ends of the openings 53 for retaining the second slide axle 212. The second pivot shafts 222 are rotatably secured to the snapping grooves 52 and the second slide axle 212 is slidably secured to the slide guide groove 51 respectively.

The FOLED module 13 comprises a rectangular FOLED sheet 131 and a light controller 132 (see FIG. 2). The microprocessor 15 is electrically connected to both the FOLED sheet 131 and the light controller 132. The FOLED sheet 131 can emit light to the undersides of the keys 10 so that different colors of the keys 10 can be seen. That is, key characters can be seen in different colors. Moreover, the light controller 132 can adjust brightness of the FOLED sheet 131.

The FOLED sheet 131 is provided under the aluminum plate 50 for illumination purpose. The light emitted by the FOLED sheet 131 to the undersides of the keys 10 can cause the multi-color keys 10 to be seen. As a result, the characters of the keys 10 are shown in a colorful manner.

In another configuration of the embodiment (not shown), the FOLED sheet 131 can be disposed either between the membrane circuit board 40 and the aluminum plate 50 or between the membrane circuit board 40 and the rubber plate 30. The purpose of illuminating the keys 10 by backlight still can be achieved.

While the invention has been described in terms of preferred embodiments, those skilled in the art will recognize that the invention can be practiced with modifications within the spirit and scope of the appended claims.

What is claimed is:

1. An illuminated computer input device comprising:
a microprocessor;
a touch pad module comprising a flexible, optically transmissive touch pad and a touch pad controller electrically interconnecting the touch pad and the microprocessor;
a virtual keys sheet functioning as a flexible, rectangular, optically transmissive characters printing membrane and disposed under the touch pad; and
a FOLED (Flexible Organic Light Emitting Diode) module comprising a FOLED sheet disposed under the virtual keys sheet, and a light controller electrically interconnecting the FOLED sheet and the microprocessor for adjusting brightness of the FOLED sheet.

2. The illuminated computer input device of claim 1, wherein a top surface of the characters printing membrane is provided with a touch area and a plurality of virtual keys each printed with a character, number, or function number.

3. The illuminated computer input device of claim 1, wherein the virtual keys sheet is an electronic paper display.

4. The illuminated computer input device of claim 3, further comprising an electronic paper display controller, the electronic paper display controller being electrically connected to the electronic paper display for forming an electronic paper display module which is electrically connected to the microprocessor.

5. The illuminated computer input device of claim 4, wherein the electronic paper display controller comprises a display micro-controller electrically connected to the microprocessor for controlling display signals of the electronic paper display, a driver chip for sending the display signals from the display micro-controller to the electronic paper display, an SRAM (Static Random Access Memory) for storing a plurality of pages of different national layouts including characters and symbols, and a power supply for supplying power to the driver chip as controlled by the display micro-controller.

6. The illuminated computer input device of claim 1, wherein the touch pad controller is adapted to convert an analog signal generated by pressing the touch pad into a digital signal, calculate position of the pressing in a form of coordinate position, convert the coordinate position into a touch signal, and send the touch signal containing the coordinate position to the microprocessor via a serial bus, further comprising a loudspeaker or a vibrator which can be activated when the touch signal is created so as to either audibly or physically alert about the successful pressing.

7. An illuminated computer input device comprising:
a microprocessor;
a virtual keys sheet functioning as a flexible, rectangular, optically transmissive characters printing membrane;
a FOLED (Flexible Organic Light Emitting Diode) module comprising a FOLED sheet disposed under the virtual keys sheet, and a light controller electrically interconnecting the FOLED sheet and the microprocessor for adjusting brightness of the FOLED sheet; and
a touch pad module disposed under the FOLED module and comprising a flexible touch pad and a touch pad controller electrically interconnecting the touch pad and the microprocessor.

8. The illuminated computer input device of claim 7, wherein a top surface of the characters printing membrane is provided with a touch area and a plurality of virtual keys each printed with a character, number, or function number.

9. The illuminated computer input device of claim 7, wherein the virtual keys sheet is an electronic paper display.

10. The illuminated computer input device of claim 9, further comprising an electronic paper display controller, the electronic paper display controller being electrically connected to the electronic paper display for forming an electronic paper display module which is electrically connected to the microprocessor.

11. The illuminated computer input device of claim 10, wherein the electronic paper display controller comprises a display micro-controller electrically connected to the microprocessor for controlling display signals of the electronic paper display, a driver chip for sending the display signals from the display micro-controller to the electronic paper display, an SRAM (Static Random Access Memory) for storing a plurality of pages of different national layouts including characters and symbols, and a power supply for supplying power to the driver chip as controlled by the display micro-controller.

12. The illuminated computer input device of claim 7, wherein the touch pad controller is adapted to convert an analog signal generated by pressing the touch pad into a digital signal, calculate position of the pressing in a form of coordinate position, convert the coordinate position into a touch signal, and send the touch signal containing the coordinate position to the microprocessor via a serial bus, further comprising a loudspeaker or a vibrator which can be activated when the touch signal is created so as to either audibly or physically alert about the successful pressing.

13. An illuminated computer input device comprising:
a plurality of transparent, rectangular keys each having a top coated with a bottom multi-color, optically transmissive dye layer and an opaque layer having portions removed so that characters printed between the key and the multi-color, optically transmissive dye layer can be viewed through the removed portions of the opaque layer;
a plurality of scissors shaped structures disposed under the keys, each scissors shaped structure comprising a first frame and a second frame pivotally secured together;
an optically transmissive rubber plate disposed under the scissors shaped structures and comprising a plurality of units each having a plurality of holes;
a membrane circuit board disposed under the rubber plate;
a rectangular aluminum plate disposed under the membrane circuit board and comprising a plurality of units each including a plurality of openings for passing light to the undersides of the keys, a plurality of snapping grooves, and a slide guide groove wherein the corresponding snapping grooves, the slide guide groove, and the scissors shaped structure are secured together; and
a FOLED sheet disposed under the aluminum plate for serving as backlight of the keys.

14. The illuminated computer input device of claim 13, further comprising a light controller together with the FOLED sheet for forming a FOLED (Flexible Organic Light Emitting Diode) module, and wherein the light controller is electrically interconnected the FOLED sheet and a microprocessor for adjusting brightness of the FOLED sheet.

15. The illuminated computer input device of claim 13, wherein on the bottom of the key there are provided two pivot grooves, two slide guide grooves, and a stem extending downward from the center; wherein the scissors shaped structure comprises two first slide axles at two corners of the first frame, two second pivot shafts at two corners of the second frame, the second pivot shafts being below the first slide axles, a first pivot shaft at the other side of the second frame, a second slide axle at the other side of the first frame parallel to and below the first pivot shaft, and a central circular hole; wherein the first slide axles are slidably secured to the slide guide grooves and the first pivot shaft is rotatably secured to the pivot grooves respectively; and wherein the snapping grooves of each unit of the aluminum plate are adapted to retain the second pivot shafts, and the slide guide groove of each unit of the aluminum plate is adapted to retain the second slide axle.

16. The illuminated computer input device of claim 13, wherein each unit of the rubber plate further comprises a resilient dome through the scissors shaped structure to retain the stem; wherein each hole of each unit of the rubber plate is adapted to have the second pivot shafts and the second slide axle disposed therein; and wherein the membrane circuit board comprises a plurality of openings each with the second pivot shafts or the second slide axle disposed therein.
